(19) United States
(12) Patent Application Publication
(10) Pub. No.: US 2025/0141248 A1
(43) Pub. Date: May 1, 2025

(54) VISUAL INDICATION DEVICE AND CHARGING DEVICE

(71) Applicant: DATATRONIC LIMITED, HONG KONG (CN)

(72) Inventors: RONALD SIU, HONG KONG (CN); KWOK CHU CHU, HONG KONG (CN); TSZ WAI LAU, HONG KONG (CH); JESSICA CHAN, HONG KONG (CN)

(21) Appl. No.: 18/383,893

(22) Filed: Oct. 25, 2023

(51) Int. Cl. H02J 7/00; H05B 47/105; H05B 47/155; H05B 47/16; H05B 47/165

(52) U.S. Cl. CPC H02J 7/0048; H02J 7/0042; H05B 47/105; H05B 47/155; H05B 47/16; H05B 47/165

(57) ABSTRACT

A visual indication device includes: device body provided with a concave portion with a surface opening; semi-transparent reflective mirror positioned to cover the surface opening of the concave portion; reflective mirror arranged on a bottom surface of the concave portion; light source located inside the device body and configured to generate light; light guide element arranged on one side of the concave portion to guide the light to refract towards the semi-transparent reflective mirror. There is a distance space between the semi-transparent mirror and the reflective mirror that can duplicate the light to be a 3D pattern from the light guide. The light effect is generated by a few light sources—LED, which can form many moving patterns by dimming and growing light. That can provide more indication messages and the look decoration to users.

### TECHNICAL FIELD

The invention relates to indication device, and in particular relates to a visual indication device and charging device.

### BACKGROUND

With the widespread use of electronic devices in daily life, charging devices, as accessories for electronic devices and user terminal, are widely used to effectively improve the battery life of electronic devices and ensure their long-lasting operation. Existing charging devices often feature indication lights or similar light indication components to provide users with a simple and quick representation of the current operating status of the charging device (e.g., whether it is charging or the remaining battery level). However, existing light indication components have limited forms and are often constrained by cost considerations. They typically use bottom-mounted LEDs as light sources, which emit light after being focused and refracted by optical components. The shapes they can display are simple (e.g., dots, bars, illuminated planes, and refraction through transparent components), and they can only provide two-dimensional light effects. The displayed light effects cannot fully meet the practical needs of usage.

### SUMMARY

In a first aspect, the present invention is provided a visual indication device. The visual indication device includes: device body provided with a concave portion with a surface opening; semi-transparent reflective mirror positioned to cover the surface opening of the concave portion; reflective mirror arranged on a bottom surface of the concave portion; light source located inside the device body and configured to generate light; light guide element arranged on one side of the concave portion to guide the light to refract towards the semi-transparent reflective mirror; wherein at least a portion of the light refracted towards the semi-transparent reflective mirror is reflected by the reflective mirror and re-enter the semi-transparent reflective mirror. There is a distance space between the semi-transparent mirror and the reflective mirror that can duplicate the light to be a 3D pattern from the light guide. The light effect is generated by a few light sources—LED, which can form many moving patterns by dimming and growing light. The light effect is generated by a few light sources—LED, which can form many moving patterns by dimming and growing light. That can provide more indication messages and the look decoration to users.

In a second aspect, the present invention is provided a charging device. The charging device includes: charging device body; visual indication device positioned on the surface of the charging device body; wherein the visual indication device includes: device body provided with a concave portion with a surface opening; semi-transparent reflective mirror positioned to cover the surface opening of the concave portion; reflective mirror arranged on a bottom surface of the concave portion; light source located inside the device body and configured to generate light; light guide element arranged on one side of the concave portion to guide the light to refract towards the semi-transparent reflective mirror; wherein at least a portion of the light refracted towards the semi-transparent reflective mirror is reflected by the reflective mirror and re-enter the semi-transparent reflective mirror. There is a distance space between the semi-transparent mirror and the reflective mirror that can duplicate the light to be a 3D pattern from the light guide. The light effect is generated by a few light sources—LED, which can form many moving patterns by dimming and growing light. The light effect is generated by a few light sources—LED, which can form many moving patterns by dimming and growing light. That can provide more indication messages and the look decoration to users.

### BRIEF DESCRIPTION OF THE DRAWINGS

One or more embodiments are described by way of example in conjunction with the accompanying drawings, which are not intended to limit the embodiments. Elements with the same reference numerals in the drawings represent similar components, unless otherwise specified. The drawings are not to scale.

FIG. 1 is a schematic diagram illustrating the structure of the visual indication device according to an embodiment of the present invention.

FIG. 2 is a schematic diagram illustrating the optical path of the visual indication device according to an embodiment of the present invention.

FIG. 3 is a schematic diagram illustrating the charging device according to an embodiment of the present invention.

FIG. 4 is a sectional view of the charging device shown in FIG. 3.

FIG. 5 is a schematic diagram illustrating the light emitted through the semi-transparent reflective mirror according to an embodiment of the present invention.

### DETAILED DESCRIPTION

The following detailed description of the invention is provided in conjunction with specific embodiments. It should be emphasized that the following description is purely exemplary and is not intended to limit the scope and application of the invention.

It should be emphasized how the light ray works by the mirror and semi-transparent media. This light effect is based on a physical principle—“infinity mirror,” which relates to the reflection and refraction between two or more semi-transparent media with a reflective function to duplicate light reflection effects. The structure is exemplary, but don't see it as a limitation or the only, exact way to achieve it. For those skilled in this field, it can make changes to the specific implementation and application scope based on the ideas, principles, and spirit according to the invention (i.e., semi-transparent media with reflective function) in order to meet the needs of practical situations or achieve one or more functions. For instance, waterproof materials may be applied to the lighting guide components to enhance waterproof performance. Any modifications, equivalent substitutions, improvements, etc., made by them should be included within the scope of protection. It should be noted that unless otherwise specified and limited, the terms “center,” “longitudinal,” “lateral,” “top,” “bottom,” “vertical,” “horizontal,” “inner,” “outer,” and the like used in this specification indicate the positional relationship based on the orientation shown in the accompanying drawings. They are used for the purpose of facilitating the description and simplifying the description of the invention, and should not be understood as limiting the invention to specific orientations or constructions and operations in specific orientations. Therefore, they should not be construed as limitations of the invention. Terms such as “mounting,” “connecting,” “linking,” “fixing,” and the like should be broadly interpreted. For example, they can refer to fixed connections, detachable connections, or integral connections; they can refer to mechanical connections or electrical connections; they can be directly connected or indirectly connected through an intermediate medium. In addition, the terms “first” and “second” are used for descriptive purposes only and should not be construed as indicating or implying relative importance or a specific quantity of the indicated technical features. Therefore, features designated as “first” or “second” may include one or more of such features, either explicitly or implicitly. The term “multiple” means two or more, and the term “and/or” includes any and all combinations of the listed items that are relevant. Ordinary skilled artisans in the field can understand the specific meanings of the above terms in the context of the invention according to specific circumstances.

FIG. 1 is a structural schematic diagram of the visual indication device provided in an embodiment of the present application. As shown in FIG. 1, the visual indication device 1 includes: a device body 10, a semi-transparent reflective mirror 20, a reflective mirror 30, a light source 40, and a light guide element 50.

The device body 10 is the main structure of the entire visual indication device. It has a recessed portion 11 with a surface opening. The recessed portion 11 can have a suitable width and depth according to practical needs.

The semi-transparent reflective mirror 20 is mounted on the surface opening of the recessed portion 11. It is a special type of optical mirror that can partially reflect light and partially transmit light. In other embodiments, it can also be referred to as a semi-transparent mirror or semi-transmissive lens.

Specifically, the semi-transparent reflective mirror is typically made by depositing a special thin film on a transparent substrate material (such as glass or plastic). This thin film can consist of multiple optical layers (e.g., metal layers and dielectric layers) and achieve the desired optical properties by controlling the thickness and refractive index of these optical layers.

The reflective mirror 30 is arranged on the bottom surface of the recessed portion 11 to reflect the partially transmitted light from the semi-transparent reflective mirror back into the next semi-transparent reflective mirror. In some embodiments, the reflective mirror 30 and the semi-transparent reflective mirror 20 are parallel to each other and spaced at a predetermined distance to allow multiple reflections between the mirrors at appropriate angles.

The light source 40 is located inside the device body 10 and serves as the module for generating light. In some embodiments, as shown in FIG. 1, the light source 40 may include an emitting element 41 and a condenser element 42.

The emitting element 41 is fixed to the device body 10 and can be any suitable light-emitting component, such as an LED chip. The condenser element 42 is a component used to converge the light rays onto a smaller area or point, such as a convex or concave lens. The condenser element 42 can be arranged and covered above the emitting element 41 to focus the light emitted from the emitting element 41.

Specifically, the condenser element 42 and the device body 10 can be produced using a secondary injection molding process. Initially, the device body, serving as the base part, can be manufactured using conventional injection molding techniques. Then, after undergoing one or more pre-processing steps (such as cleaning and surface treatment), the base part is placed in a fixture, and additional molten plastic material is injected. Finally, after the plastic has completely cooled and solidified, the final secondary injection molded product (i.e., the condenser element and the device body) can be removed from the opened fixture.

The light guide element 50 is an optical component used to control and guide the transmission of light. It can be made of transparent optical materials such as glass, plastic, or optical fibers to transfer light from one location to another. In this embodiment, the light guide element 50 can be arranged on one side of the recessed portion 11, forming a light-guiding pathway to refract the light towards the semi-transparent reflective mirror 20.

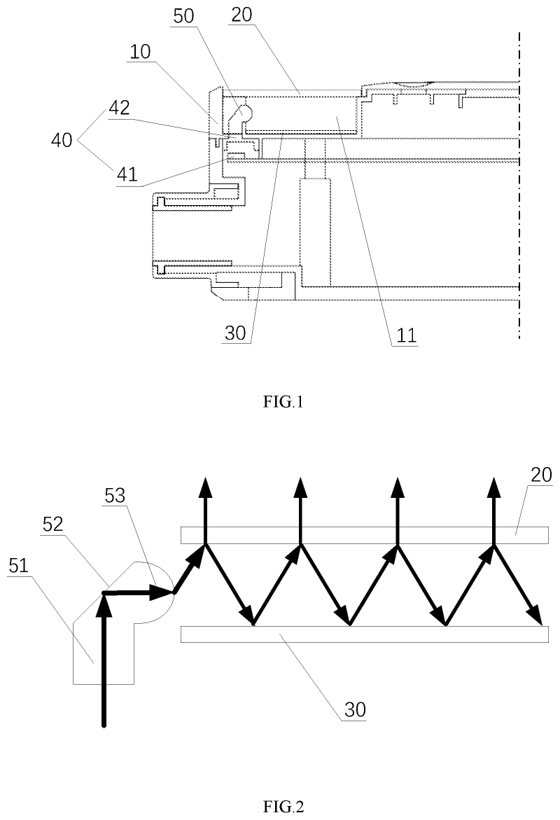

Specifically, as shown in FIG. 2, the light guide element 50 can be divided into three parts: the light incident end 51, the inclined reflecting surface 52, and the light exit end 53.

The light exit end 53 can be set to a predetermined shape and/or specific refractive index to refract the light onto the semi-transparent reflective mirror 20 at a desired angle.

The inclined reflecting surface 52 forms a 45° angle with the reflective mirror 30, allowing the light generated by the light source to enter the reflecting surface 52 in a direction perpendicular to the reflective mirror, change direction to become parallel to the reflective mirror, and exit from the light exit end 52.

During actual usage, the light enters through the light incident end 51, undergoes reflection on the inclined reflecting surface 52, changes direction, and moves towards the light exit end 53. Finally, the light is emitted from the light exit end 53, refracting towards the position where the semi-transparent reflective mirror 20 is located.

In some embodiments, the device body 10 can be ring-shaped. The recessed portion 11 is a ring-shaped groove with a predetermined width and depth.

Correspondingly, the aforementioned semi-transparent reflective mirror 20 is also ring-shaped and is placed on the surface opening of the recessed portion 11. Ideally, there can be at least four of these ring-shaped semi-transparent reflective mirrors. The centers of these ring-shaped semi-transparent reflective mirrors coincide and are arranged along the width direction of the ring-shaped groove.

For instance, as shown in FIG. 2, with the action of the light guide element 50, the light is first refracted onto a first semi-transparent reflective mirror. A part of the light may emit from a first semi-transparent reflective mirror and the rest of the light may undergoes multiple reflections and refractions between subsequent semi-transparent reflective mirrors and reflective mirrors. There is a distance space between the semi-transparent mirror and the reflective mirror that can duplicate the light to be a 3D pattern from the light guide.

During each entry of the light into a semi-transparent reflective mirror, a portion of the light exits through the semi-transparent reflective mirror, while another portion is reflected onto the reflective mirror and re-enters the next semi-transparent reflective mirror.

Specifically, the overlapping images formed by the light emitted through different semi-transparent reflective mirrors can create a 3D-like lighting effect and produce different lighting effects as observed from different viewing angles.

In the visual indication device provided in this embodiment, the light generated by the emitting element 41 passes through the condenser element 42, refracts onto the semi-transparent reflective mirror 20 under the guidance of the light guide element 50, and then undergoes multiple reflections through the reflective mirror 30. Some of the light can penetrate the semi-transparent reflective mirror 20 and project outward.

The refracted and reflected light can create a 3D effect. The repetitive scenes of the continuously reflected light change at different angles. Moreover, the lighting effect can have different shapes and combinations. On one hand, different shapes can be reflected using the reflective mirror, and on the other hand, the shape of the light effect can be changed by replacing the light guide element with a different shape, making the product appearance more flexible and versatile.

At least one advanced aspect of the visual indication device is that: the light effect can be generated by a few light sources (i.e., LED), which can form many moving patterns by dimming and growing light. Accordingly, more indication messages and the look decoration can provide to users.

In some embodiments, a lighting effect image generating by the visual indication device has different displays according to different situations, such as: discoloration, flickering, light and dark of breathing frequency, clockwise or counterclockwise rotating light effect. It is a bit like a time tunnel penetrating through the main shell, which cannot be achieved by traditional LED lights. In this way, it is ensured that the person who observes the state of the charger can easily notice the state of the indicator light, and the effect of convenient use is realized.

Based on the above-mentioned visual indication device, this application further provides a charging device. The surface of the charging device is equipped with the aforementioned visual indication device, which can seamlessly integrate with the product design. By utilizing its rich lighting effects to display information, it effectively enhances the user experience and facilitates timely attention to the indication lights or other types of interactive information feedback from the charging device.

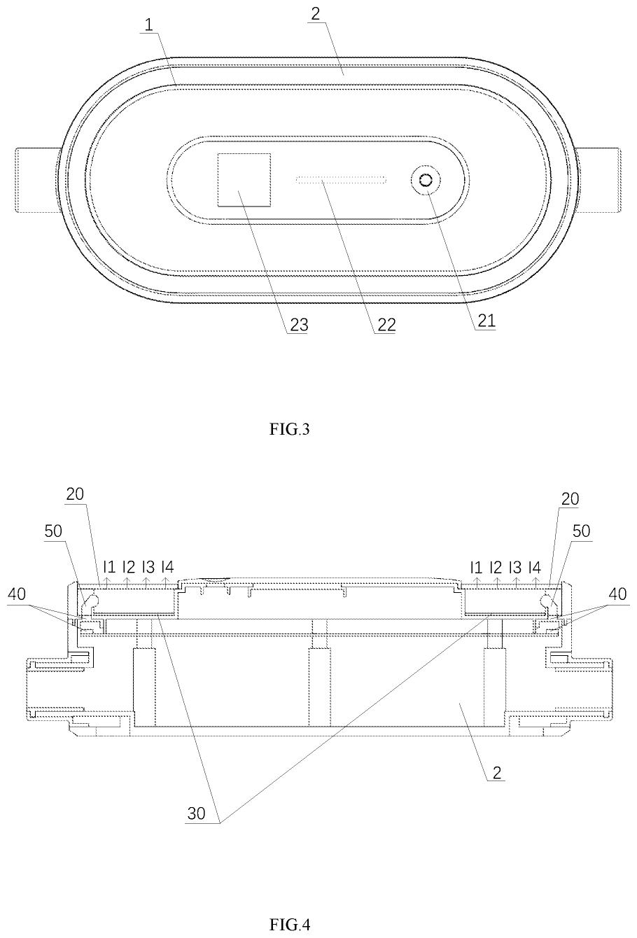

FIG. 3 is a schematic diagram illustrating the structure of the charging device provided in this embodiment. As shown in FIG. 3, the charging device includes a visual indication device 1 and a charging device body 2.

The charging device body 2 can be designed in a suitable shape according to practical needs. It has two opposing end faces, and the visual indication device 1 is installed on one of the end faces. The interior of the charging device body 2 can also be equipped with a battery core, control panel, and other functional modules to achieve the charging function for external electronic devices.

In some embodiments, the charging device may also include a series of interactive devices, such as control buttons 21, indication lights 22, and a screen 23, to assist users in controlling the charging device and understanding its operational status.

In some embodiments, the control buttons 21, indication lights 22, and screen 23 can be surrounded by the ring-shaped visual indication device 1. By utilizing the special lighting effects generated by the visual indication device 1, users can easily observe the status of the indication lights 22.

In some embodiments, the visual indication device 1 can generate various visual effects in response to changes in the charging device's status. For example, the visual effects can include one or more of the following: changing light colors, light flickering, varying the brightness modulation cycle, and rotating light effects in different directions (clockwise or counterclockwise).

During actual usage, the aforementioned indication lights 22 can also exhibit different response lighting effects based on the pressing actions of the control buttons 21. For instance, the indication lights 22 can illuminate for a preset duration in response to the first press of the control button 21. Alternatively, the indication lights 22 can gradually illuminate in response to the second press of the control button 21 and turn off when the pressing action ends.

The first press operation and second press operation are used to distinguish the press operation in different pressing durations. For example, the first press action can be a short press, while the second press action can be a long press.

Furthermore, the screen 23 can display relevant functional pages and charging device information based on the user's pressing actions on the buttons.

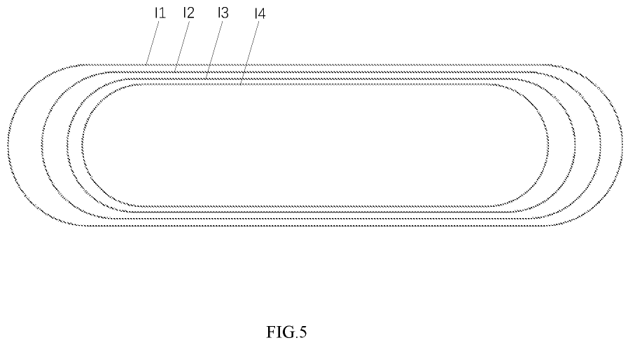

FIG. 4 is a sectional view of the charging device. In this embodiment, there are four semi-transparent reflective mirrors mounted on the ring-shaped groove. Four semi-transparent reflective mirrors are numbered sequentially as first semi-transparent reflective mirrors, second semi-transparent reflective mirrors, third semi-transparent reflective mirrors and fourth semi-transparent reflective mirrors. As shown in FIG. 4, when the light enters a first semi-transparent reflective mirror, a part of the light may emit (it can be labeled as I1) and the rest of the light may reflect to the reflective mirror 20. The reflective mirror 20 can reflect it to a second semi-transparent reflective mirror. Then, a part of the light will emit from the second semi-transparent reflective mirror (it can be labeled as I2). Following the same logic, the light I3 and I4 emit from third and fourth semi-transparent reflective mirror, respectively. FIG. 5 illustrate the light I1, I2, I3 and I4 emit from four semi-transparent reflective mirrors.

The above content provides further detailed explanations in conjunction with specific/preferred embodiments, but it should not be construed that the specific embodiments of the invention are limited to these explanations. Those skilled in the art can make various modifications and improvements within the scope of the invention without departing from the underlying concept, and all such modifications and improvements fall within the protection scope of the invention.

What is claimed is:

1. A visual indication device, comprising:
a device body provided with a concave portion with a surface opening;
at least one semi-transparent reflective mirrors positioned to cover the surface opening of the concave portion;
a reflective mirror arranged on a bottom surface of the concave portion;
a light source located inside the device body and configured to generate light;
a light guide element arranged on one side of the concave portion to guide the light to refract towards the semi-transparent reflective mirror;
wherein at least a portion of the light refracted towards the semi-transparent reflective mirror is reflected by the reflective mirror and re-enter the semi-transparent reflective mirror.

2. The visual indication device according to claim 1, wherein the light source comprises: a light-emitting element and a condenser element;
wherein the light-emitting element is fixed on the device body and the condenser element is arranged above the light-emitting element to focus the light generated by the light-emitting element.

3. The visual indication device according to claim 2, wherein a light effect of the visual indication device is generated by a few light source; the light-emitting element of the light source is LED, configured to form many moving patterns by dimming and growing light, such that more indication messages and look decoration is provided to users.

4. The visual indication device according to claim 2, wherein the condenser element is obtained by secondary injection molding process in conjunction with the device body.

5. The visual indication device according to claim 1, wherein the light guide element comprises: a light incident end, a reflecting surface, and a light exit end;
wherein an angle between the inclined surface and the reflective mirror is 45°; the light generated by the light source enters the reflecting surface in a direction perpendicular to the reflective mirror wherein the light exit end has a predetermined shape to refract the light at a predetermined angle towards the semi-transparent reflective mirror.

6. The visual indication device according to claim 1, wherein the device body is ring-shaped and the concave portion is a ring-shaped groove with a predetermined width and depth; the semi-transparent reflective mirror is ring-shaped and is provided with at least four mirrors; the centers of at least four ring-shaped semi-transparent mirrors coincide and are arranged along the width direction of the ring-shaped groove.

7. The visual indication device according to claim 1, wherein a predetermined distance is between the semi-transparent reflective mirror and the reflective mirror, and the reflective mirror is parallel to the semi-transparent reflective mirror, such that the light undergoes multiple reflections and refractions between the semi-transparent reflective mirror and the reflective mirror.

8. The visual indication device according to claim 1, wherein the light guide element is a replaceable component; different shapes of the light guide element result in different lighting display effects.

9. The visual indication device according to claim 1, wherein a distance space between the semi-transparent reflective mirror and the reflective mirror that can duplicate the light to be a 3D pattern from the light guide.

10. A charging device, comprising:
a charging device body;
a visual indication device positioned on the surface of the charging device body;
wherein the visual indication device comprises:
a device body provided with a concave portion with a surface opening;
at least one semi-transparent reflective mirror positioned to cover the surface opening of the concave portion;
a reflective mirror arranged on a bottom surface of the concave portion;
a light source located inside the device body and configured to generate light;
a light guide element arranged on one side of the concave portion to guide the light to refract towards the semi-transparent reflective mirror;
wherein at least a portion of the light refracted towards the semi-transparent reflective mirror is reflected by the reflective mirror and re-enter the semi-transparent reflective mirror.

11. The charging device according to claim 10, wherein the light source comprises: a light-emitting element and a condenser element;
wherein the light-emitting element is fixed on the device body and the condenser element is arranged above the light-emitting element to focus the light generated by the light-emitting element;
wherein a light effect of the visual indication device is generated by a few light source; the light-emitting element of the light source is LED, configured to form many moving patterns by dimming and growing light, such that more indication messages and look decoration is provided to users.

12. The charging device according to claim 11, wherein the condenser element is obtained by secondary injection molding process in conjunction with the device body.

13. The charging device according to claim 10, wherein the light guide element comprises: a light incident end, a reflecting surface, and a light exit end;
wherein an angle between the inclined surface and the reflective mirror is 45°; the light generated by the light source enters the reflecting surface in a direction perpendicular to the reflective mirror.

14. The charging device according to claim 10, wherein the device body is ring-shaped, and the concave portion is a ring-shaped groove with a predetermined width and depth.

15. The charging device according to claim 14, wherein the charging device further comprises: control buttons, indication lights, and a screen;
wherein the control buttons, control indication lights, and screen are surrounded by the ring-shaped charging device.

16. The charging device according to claim 15, wherein the visual indication device responds to changes in a state of the charging device, resulting in corresponding lighting effect images; and the visual effects change is selected from discoloration, flickering, light and dark of breathing frequency, clockwise or counterclockwise rotating light effect.

17. The charging device according to claim 16, wherein the indication lights illuminate for a predetermined time in response to a first press operation of the control buttons; and
the indication lights gradually light up in response to a second press operation of the control buttons and turn off when the second pressing operation ends.

18. The charging device according to claim 14, wherein the semi-transparent reflective mirror is ring-shaped and is provided with at least four mirrors; the centers of at least four ring-shaped semi-transparent mirrors coincide and are arranged along the width direction of the ring-shaped groove.

19. The charging device according to claim 18, wherein a distance space between the semi-transparent reflective mirror and the reflective mirror that can duplicate the light to be a 3D pattern from the light guide, by means of letting
the light undergoes multiple reflections and refractions between the semi-transparent reflective mirror and the reflective mirror.

20. The charging device according to claim 10, wherein the charging device body has two opposite end faces; and the visual indication device is positioned on one of the end faces.
